(19) United States
(12) Patent Application Publication
(10) Pub. No.: US 2009/0207707 A1
(43) Pub. Date: Aug. 20, 2009

(54) OPTICAL RECORDING APPARATUS

(75) Inventor: James Joseph Anthony McCormack, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/305,023

(22) PCT Filed: Jun. 5, 2007
(86) PCT No.: PCT/IB2007/052101

§ 371 Date: Dec. 16, 2008

(30) Foreign Application Priority Data
Jun. 19, 2006 (EP) 06115635.2

(51) Int. Cl. G11B 20/00; G11B 7/00

(52) U.S. Cl. 369/47.19; 369/100; G9B/7; G9B/20

(57) ABSTRACT

The present invention relates to an optical recording apparatus that provides improved writing speed. In the processing means (50) an encoded data signal (NRZ) is processed, and a first clock generator (52) generates a two-level clock signal (CLK). Furthermore, a duty cycle modulator (MOD) modulates the clock signal (CLK) in response to the encoded data signal (NRZ) so as to vary the duty cycle of the clock signal (CLK), possibly with a plurality of phases. The resulting single, combined data and clock signal (NRZ_CLK) is transmitted to the optical pick-up unit (OPU; 20) where a second clock generator (24) extracts a retrieved clock signal (CLKr) from the combined signal (NRZ_CLK), and a data demodulator (DEMOD; 23) extracts the encoded data signal (NRZ) using said retrieved clock signal (CLKr). Thereby, a fast and reliable bandwidth is obtained in the communication between the processing means and the optical pick-up (OPU; 20.

The present invention relates to an optical recording apparatus, corresponding processing means for controlling an optical recording apparatus, and a corresponding method for operating an optical recording apparatus. In particular, the present invention provides improved writing speed for an optical recording apparatus.

An optical recording drive normally has a displaceable optical pick-up unit (OPU) positioned in opposed and proximate relationship to the optical disk. The OPU is then connected to a central digital signal processor (DSP) via a flexible signal transmission path section, also known in the art as the “flex” or “flex cable”. The path section may be a plurality of flat conducting lines sandwiched between two films or a set of collected coated flexible wires. The flex allows for sufficient displacement of the OPU while simultaneously keeping the OPU connected to the DSP. The DSP (or a similar unit) controls the operation of the OPU and feeds the OPU with encoded data and a clocking signal, see e.g. US patent application 2004/033814.

Within the optical pick-up unit (OPU), a laser is positioned for writing so that during optical recording of an optical disk or carrier, for rewriteable media, a laser beam is applied to selectively crystallize or make amorphous a phase-changing material in dependency of the data to be written on the optical disk or carrier. Equally, for write-once media, a laser beam is applied to selectively alter/burn away/deform (dye) material or not, in dependency of the data to be written on the optical disk or carrier.

The laser is driven by using a pulse form that contains a higher frequency component than the channel rate itself. This has the form of a multi-level pulse with the purpose of writing a “mark” or a “space” at a given length in response to the encoded data. The conversion of encoded data, also known as no-return-to-zero data (NRZ), alternatively eight-to-fourteen modulated (EFM) data, to a pulse train with higher time resolution and multiple power levels is performed by a so-called write strategy generator (WSG) located on the OPU.

With the current trend of increasing writing speed to the optical disk, in particular for the Blu-Ray Disc (BD), the parallel transmission of encoded data and a clocking signal from the DSP to the OPU is approaching an upper limit. This is because the bandwidth, the load of the flex, and minor length differences within the flex result in various frequency dependent signal propagation delays in the transmitted data and/or the clock signal. The flex loading is also dependent on the physical position of the flex, which varies as the OPU moves between the inner and outer diameters of the disc. Moreover, the encoded data needs a reliable set-up and hold time relative to the clocking signal. Estimates show that the BD 7× writing speed (466 MHz/2.2 nanoseconds) represents such an upper limit.

A solution for reducing the constraints imposed by the flex, and in turn increasing the writing speed of the optical drive, is disclosed in WO 2005/001829 to the same applicant, WO 2005/001829 being hereby included by reference in its entirety. A signal containing data information and clock information is transferred over one common transfer path, i.e. flex from an encoder to the OPU and a corresponding driver circuit. The driver circuit is arranged for generating a digital data signal and a digital clock signal from the single encoded signal received from the encoder. Two different ways of obtaining the combined signal are disclosed in WO 2005/001829:

In a first embodiment, the encoded data signal itself is transmitted to the OPU, where clock regeneration means, e.g. a PLL device, are arranged for retrieving a clocking signal from the data signal. However, this has the disadvantage that the channel clock frequency signal has to be retrieved from the data signal which is relatively imprecise and requires additional circuitry.

In a second embodiment of WO 2005/001829, the encoded data signal is combined with the clocking signal by multiplexing means. In particular, the combined signal may be a 3 or 4 level-based signal. On the receiving side, demultiplexing means are provided for extracting the data and clock signal again. However, by introducing multilevel demultiplexing it is not feasible to apply standard differential two-level signal connection (e.g. low-voltage differential signalling, LVDS), which in turn complicates the design of the OPU.

Hence, an improved optical recording apparatus would be advantageous, and in particular a more efficient and/or reliable optical recording apparatus would be advantageous.

Accordingly, the invention preferably seeks to mitigate, alleviate or eliminate one or more of the above-mentioned disadvantages singly or in any combination. In particular, it may be seen as an object of the present invention to provide an optical recording apparatus that solves the above mentioned problems of the prior art of increasing the writing speed to an optical carrier.

This object and several other objects are obtained in a first aspect of the invention by providing an optical recording apparatus for recording information on an associated optical carrier, said apparatus comprising:

processing means arranged for processing an encoded data signal (NRZ), said processing means comprising:

a first clock generator capable of generating a two-level clock signal (CLK), and

a duty cycle modulator arranged for modulating said clock signal (CLK) in response to the encoded data signal (NRZ) so as to vary the duty cycle of said clock signal (CLK) and outputting a single, combined data and clock signal (NRZ_CLK), and

an optical pick-up unit (OPU) comprising an irradiation source and a corresponding drive device (LDD), said optical pick-up unit being operably connected to the processing means for receiving said combined signal (NRZ_CLK), said drive device comprising:

a second clock generator capable of extracting a retrieved clock signal (CLKr) from the combined signal (NRZ_CLK), and

a data demodulator capable of extracting said encoded data signal (NRZ) using said retrieved clock signal (CLKr).

The invention is particularly, but not exclusively, advantageous for obtaining an optical drive or optical recording apparatus that is capable of having a fast and reliable bandwidth in the communication between the processing means of the optical recording apparatus and the optical pick-up (OPU) of the optical recording apparatus. In particular, for writing information with in a Blu-Ray disk system, the present invention provides a superior solution relative to the hitherto known solutions in the prior art. The present invention is considered an important milestone on the way towards 12× BD writing and above. The nature of the single asynchronous solution for the clock and data transmission provides a range of advantages relative to a parallel synchronous solution, which is normally applied in the present optical recording systems. While WO 2005/001829 suggests an alternative single asynchronous solution for the clock and data transmission to the optical pick-up unit (OPU), the solutions of that disclosure do not gain the full potential of the single asynchronous solution for the clock and data transmission due to the relatively complicated and/or imprecise embodiments of WO 2005/001829 as discussed above.

In an embodiment of the present invention, the drive device (LDD) may be operably connected to the processing means through a single electrical conductor means arranged for transmitting the single, combined data and clock signal (NRZ_CLK). Thus, the single signal can have one connection in a common transfer path; however, other control signals may also be transmitted in the flex.

In an advantageous embodiment, the drive device (LDD) may further comprise resampling means arranged for resampling and outputting the encoded data signal (NRZ) in order to improve the quality of the extracted data. In order to further improve the extracted data, the second clock generator may be adapted to extract the two-level clock signal (CLK). Thus, the retrieved clock signal (CLKr) may be equal to the two-level clock signal (CLK). This can be performed by phase lock loop (PLL) detection circuits or similar electronic means.

In another embodiment, the data demodulator in the OPU may comprise a plurality of parallel demodulating sub-units, and the resampling means comprises a corresponding plurality of resampling sub-units, said sub-units being collectively arranged to demodulate and resample a plurality (m) of encoded data channels. Furthermore, each of the encoded data channels of the plurality (m) of encoded data channels may be assigned to a separate phase of the two-level clock frequency signal (CLK). This allows for parallel processing in the OPU at a lower frequency than would otherwise be possible. Additionally, a write strategy generator in the OPU should be adapted for parallel processing of incoming encoded data.

Preferably, the two-level clock signal (CLK) may be duty-cycle modulated by a phase-modulation relative to a rising edge or a falling edge of the two-level clock signal (CLK). Thus, the rising edge may be fixed relative to an un-modulated signal, while the declining edge may be shifted in response to the data signal. This may ensure good clock signal detection from the un-modulated rising edge. Advantageously, the phase-modulation may be chosen so as to optimise the resampling performed by the resampling means. Possibly, said phase-modulation to optimise resampling may be performed during a calibration procedure prior to writing itself or during an intermission during writing.

In a highly advantageous embodiment of the present invention, a plurality of phases is applied in modulating said clock signal (CLK). In the simplest case, two phases of equal magnitude, but of opposite sign, can be applied in response to two values of the data signal (NRZ), e.g. high and low. However, the present invention may readily be extended for using three, four, five, six and more different phases in order to modulate the clock signal (CLK) in response to the data signal (NRZ). Thus, the data signal (NRZ) can be a multi-level signal represented by a corresponding number of phases. Alternatively or additionally, one phase value may represent a predefined set of data values, and by having a sufficient number of available phases, modulation or encoding can be performed.

The optical recording apparatus according to the present invention may beneficially be operated in constant angular velocity (CAV) mode, because frequency scaling is inherent in the invention.

In a second aspect, the present invention relates to processing means adapted for controlling an associated optical recording apparatus for recording information on an optical carrier, the processing means being arranged for processing an encoded data signal (NRZ), said processing means comprising:

a first clock generator capable of generating a two-level clock signal (CLK), and

a duty cycle modulator arranged for modulating said clock signal (CLK) in response to the encoded data signal (NRZ) so as to vary the duty cycle of said clock signal (CLK), and outputting a single, combined data and clock signal (NRZ_CLK) intended for transmission to an associated optical pick-up unit (OPU) of the optical recording apparatus.

In a third aspect, the present invention relates to a method for operating an optical recording apparatus for recording information on an optical carrier, said method comprising the steps of:

processing by processing means an encoded data signal (NRZ),

generating by a first clock generator a two-level clock signal (CLK), and

modulating by a duty cycle modulator said clock signal (CLK) in response to the encoded data signal (NRZ) so as to vary the duty cycle of said clock signal (CLK), and outputting a single, combined data and clock signal (NRZ_CLK),

extracting by a second clock generator a retrieved clock signal (CLKr) from the combined signal (NRZ_CLK), said second clock generator being positioned in an optical pick-up unit (OPU) comprising an irradiation source and a corresponding drive device (LDD), said optical pick-up unit being operably connected to the processing means for receiving said combined signal (NRZ_CLK), and

extracting by a data demodulator said encoded data signal (NRZ) using said retrieved clock signal (CLKr).

In a fourth aspect, the invention relates to a computer program product being adapted to enable a computer system comprising at least one computer having data storage means associated therewith to control an optical recording apparatus according to the third aspect of the invention.

This aspect of the invention is particularly, but not exclusively, advantageous in that the present invention may be implemented by a computer program product enabling a computer system to perform the operations of the second aspect of the invention. Thus, it is contemplated that some known optical recording apparatus may be changed to operate according to the present invention by installing a computer program product on a computer system controlling the said optical recording apparatus. Such a computer program product may be provided on any kind of computer readable medium, e.g. magnetically or optically based medium, or through a computer based network, e.g. the Internet.

The first, second, third and fourth aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

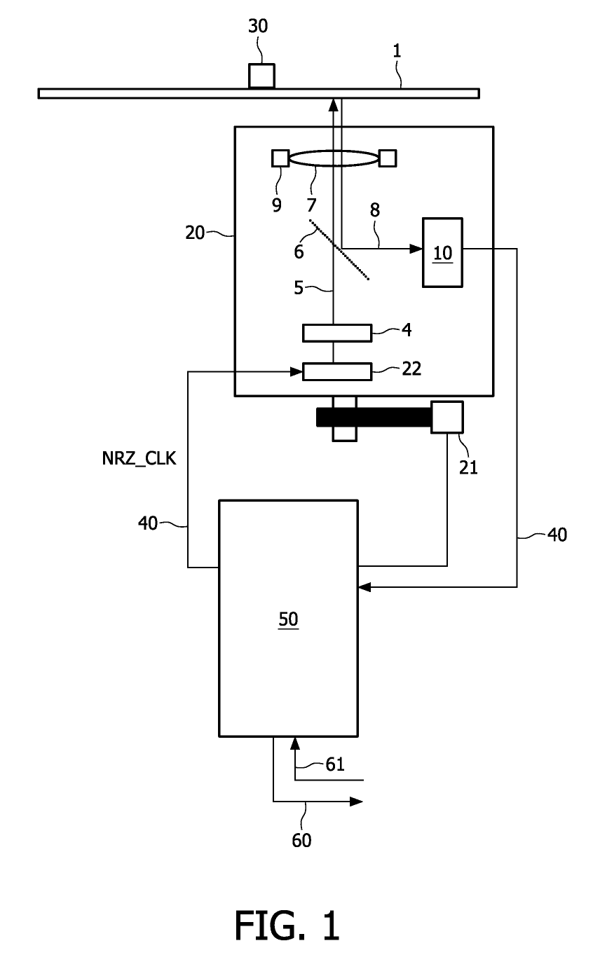

FIG. 1 schematically shows an optical recording apparatus or drive and an optical information carrier according to the present invention,

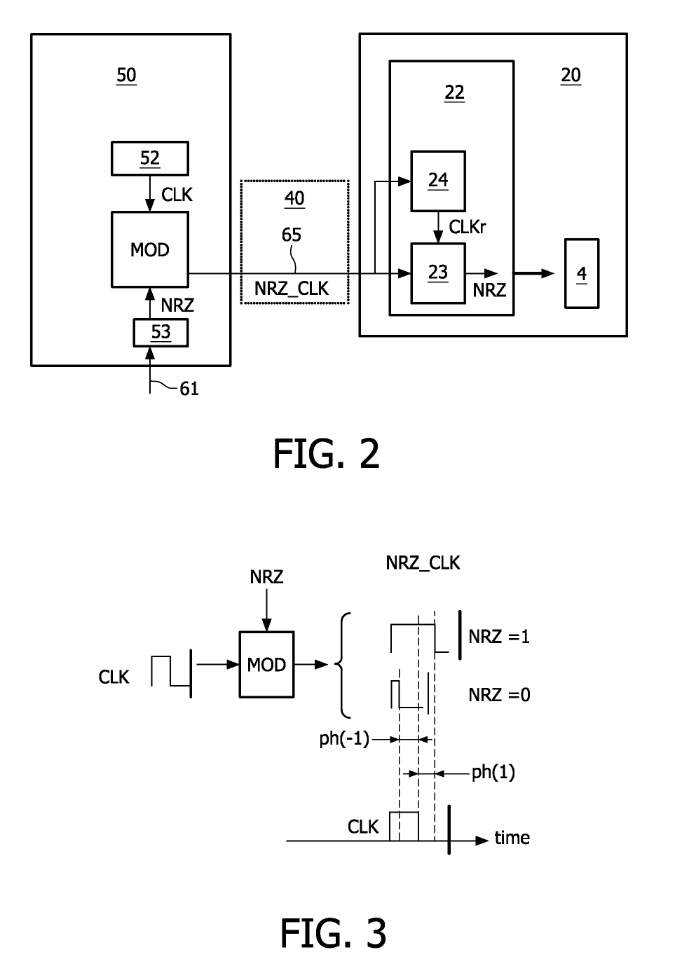

FIG. 2 schematically shows the processing means, the optical pick-up unit (OPU), and the flexible transmission path connecting the processing means and the optical pick-up unit (OPU) according to the invention,

FIG. 3 shows how the clock signal is duty-cycle modulated with the encoded data signal (NRZ) resulting in a single, combined signal according to the present invention,

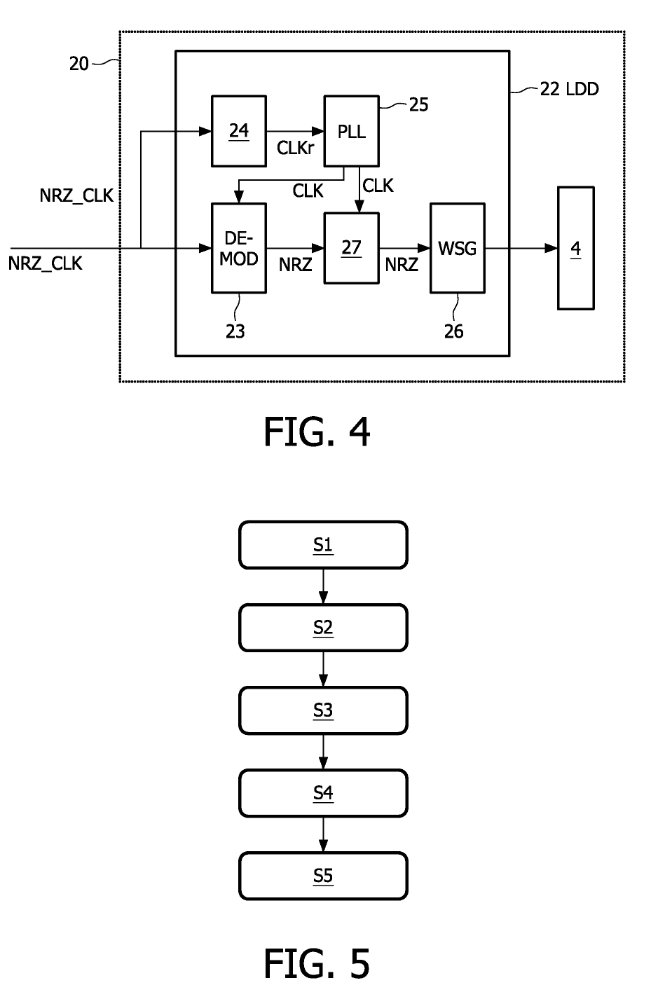

FIG. 4 schematically shows an embodiment of the optical pick-up unit (OPU) according to the present invention, and

FIG. 5 is a flow-chart of a method according to the invention.

FIG. 1 shows an optical recording apparatus or drive and an optical information carrier 1 according to the invention. The carrier 1 is fixed and rotated by holding means 30.

The carrier 1 comprises a material suitable for recording information by means of a radiation beam 5. The recording material may, for example, be of the magneto-optical type, the phase-change type, the dye type, metal alloys like Cu/Si or any other suitable material. Information may be recorded in the form of optically detectable effects, also called “marks” for rewriteable media and “pits” for write-once media, on the optical carrier 1.

The optical apparatus, i.e. the optical drive, comprises an optical head 20, sometimes called an optical pick-up (OPU), the optical head 20 being displaceable by actuation means 21, e.g. an electric stepping motor. The optical head 20 comprises a photo detection system 10, a laser driver device 30, a radiation source 4, a beam splitter 6, an objective lens 7, and lens displacement means 9 capable of displacing the lens 7 both in a radial direction of the carrier 1 and in the focus direction.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another and with a sufficient time resolution so as to enable detection of error signals, i.e. focus error FE and radial tracking error RE. The focus error FE and radial tracking error RE signals are transmitted to the processor 50 where a commonly known servomechanism operated by using PID control means (proportional-integrate-differentiate) is applied for controlling the radial position and focus position of the radiation beam 5 on the carrier 1.

The radiation source 4 for emitting a radiation beam or a light beam 5 can for example be a semiconductor laser with a variable power, possibly also with variable wavelength of radiation. Alternatively, the radiation source 4 may comprise more than one laser. In the context of the present invention the term “light” is considered to comprise any kind of electromagnetic radiation suitable for optical recording and/or reproduction, such as visible light, ultraviolet light (UV), infrared light (IR), etc.

The radiation source 4 is controlled by the laser driver device (LD) 22. The laser driver (LD) 22 comprises electronic circuitry means (not shown in FIG. 1) for providing a drive current to the radiation source 4 in response to a single, combined data and clock signal NRZ_CLK transmitted from the processor 50 through the common transfer path 40, i.e. the flex.

The processor 50 also receives and analyses signals from the photo detection means 10 through the common transfer path 40. The processor 50 can also output control signals to the actuation means 21, the radiation source 4, the lens displacement means 9, and the rotating means 30, as schematically illustrated in FIG. 1. Similarly, the processor 50 can receive data to be written, indicated at 61, and the processor 50 may output data from the reading process as indicated at 60. While the processor 50 has been depicted as a single unit in FIG. 1, it is to be understood that equivalently the processor 50 may be a plurality of interconnecting processing units positioned in the optical recording apparatus, possibly some of the units may be positioned in the optical head 20.

FIG. 2 schematically shows in more detail the processing means 50, the optical pick-up unit (OPU) 20, and the flexible transmission path 40 (the “flex”) connecting the processing means 50 and the optical pick-up unit (OPU) 20.

The processing means 50 receives data 61 to be written on the optical carrier 1 (not shown in FIG. 2). The data is initially encoded by a conventional encoder 53. The encoding is performed according to the appropriate format of the carrier 1.

Data recording on various carrier formats, such as the compact disc (CD) format, the digital versatile disc (DVD), and the Blu-Ray disc (BD), is performed by encoding the data 61 according to a standard encoding scheme to obtain a NRZ signal to be transmitted to the optical head 20 for writing. In the table below, corresponding carrier formats and encoding schemes are listed:

| Carrier formats | Encoding scheme |
|---|---|
| CD | 2, 10 EFM |
| DVD | 2, 10 EFM+ |
| BD | 1, 7 PP |

EFM is the commonly known abbreviation for Eight-to-Fourteen Modulation, and PP is an abbreviation for partial product. The present invention is not limited to the above listed carrier formats. Rather, the invention is particularly suited for obtaining high writing speeds on optical carriers in general.

The processing means 50 is operated, at least in some sub-areas and/or for some procedures, at a certain clock frequency given by a channel clock frequency or derivates thereof (e.g. at half or a quarter of the channel clock frequency). For e.g. a Blu-Ray disk (BD) being written at 1×, this frequency is approx. 66 MHz. For 2× writing it is 132 MHz and so forth. The clock signal CLK as generated by the clock generating means 52 according to the present invention may advantageously be related or derived from said channel clock frequency, but need not be so. The signal CLK may be derived from the channel clock frequency by e.g. frequency division. Thus, the frequency of the signal CLK times an integer n (or possibly a non-integer constant) can be substantially equal to the channel clock frequency. More specifically, the integer n could be 2, 3, 4, 5, 6, 7, 8, 9, 10, 11, 12, 13, 14, 15, 16, 17, 18, 19, or 20 or even higher. In that respect, the meaning of the term “clock generator” may be taken to include a frequency divider or similar circuits.

The frequency of the clock signal CLK could, e.g. for Blu-Ray Disc (BD) writing, be in the interval from 50-500 MHz, or 100-400 MHz, or alternatively 200-300 MHz. The frequency of the clock signal CLK could in another embodiment be limited to a maximum of 1000 MHz, 900 MHz, 800 MHz, 700 MHz, 600 MHz, 500 MHz, 400 MHz, 350 MHz, 300 MHz, 250 MHz, 200 MHz, 150 MHz, or 100 MHz. In particular, the frequency of the clock signal CLK and/or the combined signal NRZ_CLK can be set below the frequency bandwidth of the flex 40 so as to obtain substantially undistorted transmission to the OPU 20. With the present flex cable technology, this limit is around 150 MHz to 200 MHz.

A modulator MOD is arranged for duty-cycle modulating the clock signal CLK with the encoded data signal NRZ so as to vary the duty cycle of said clock signal CLK, and outputting a single, combined data and clock signal NRZ_CLK. This can be done by a phase modulator or other modulation means readily available to the skilled person once the general principle of the present invention is acknowledged.

The duty cycle may be defined, at least for an ideal pulse of rectangular pulses, as the ratio (%) of the pulse duration to the pulse period. For example, the duty cycle is 25% for a pulse train having pulse duration of 10 nanoseconds and a pulse period of 40 nanoseconds.

FIG. 3 schematically shows how the clock signal CLK is modulated with the encoded data signal NRZ resulting in a single, combined signal NRZ_CLK by using a phase modulator MOD. In FIG. 3, a single, rectangular two-level clock pulse CLK is inputted in the phase modulator. In response to the NRZ data signal, the duty cycle of the combined signal NRZ_CLK is increased when the NRZ data signal is high (NRZ=1), while the duty cycle is decreased when the NRZ data signal is low (NRZ=0).

In the lower part of FIG. 3, the duty-cycled modulated signal NRZ_CLK is compared to an un-modulated clock signal CLK. It is seen that the modulation embodiment of FIG. 3 changes the failing edge of the modulated signal NRZ_CLK in response to the NRZ data signal. Thus, for NRZ=1 the failing edge is shifted with a phase ph(1), while for NRZ=0 the failing edge is shifted with a phase (−1).

The two phases ph(−1) and ph(1) may be equal in magnitude or they may be different. Similarly, the phase-modulation may be performed on the rising edge of the clock signal CLK instead of the failing edge as shown in the embodiment of FIG. 3. Additionally, both the failing edge and the rising edge may be phase-modulated in response to the NRZ data signal. However, for stable clock detection on the receiving side, i.e. in the OPU 20, it is preferred that one edge is not modulated in response to the NRZ data signal in order to facilitate robust clock detection as will be explained in more detail below.

In FIG. 3, the data signal NRZ comprises two levels i.e. NRZ=1 “High” and NRZ=0 “Low”. However, in an embodiment of the invention a multiple-level data signal (not shown in FIG. 3) can be encoded by phase-modulating the clock signal CLK with a corresponding number of phases. Thus, for a 3 or 4-level data signal the clock signal CLK may have the failing edge phase modulated with 3 or 4 different phases, respectively.

In another embodiment of the invention, the frequency of the clock signal CLK can be decreased while simultaneously increasing the number of phases. Thus, by lowering the frequency of the two-level clock signal CLK and correspondingly increasing the number of phases the information content of the combined single signal NRZ_CLK can be maintained, possibly even increased. Thus, one phase value may represent a predefined set of data values, and by having a sufficient number of available phases, modulation or encoding can be performed.

As shown in FIG. 2, the single, combined signal NRZ_CLK is transmitted to the optical pick-up unit (OPU) 20. The unit 20 comprises an irradiation source 4 and a corresponding drive device (LDD) 22 operably connected to the processing means 50 for receiving said combined signal NRZ_CLK through the common transfer path 40, i.e. the flex, where a single electrical conductor means 65 is arranged for transmitting the single, combined signal NRZ_CLK. In this embodiment, just one connection 65 is shown in a flex; however, other control signals are transmitted in the path 40, too, as explained in connection with the description of FIG. 1 above. The electrical conductor means 65 can be a differential two-level signal connection, e.g. a LVDS connection or the like, or it can be a serial connection depending on the frequency requirements and electromagnetic shielding (EMC) needed.

The drive device (LDD) 22 comprises a second clock generator 24 capable of extracting a retrieved clock signal CLKr from the combined signal NRZ_CLK, and a data demodulator 23 capable of extracting the encoded data signal NRZ using said retrieved clock signal CLKr, which is shown in FIG. 2 to be transmitted to the demodulator 23 from the second clock generator 24. The encoded data signal NRZ is then processed and used to control the irradiation source 4 by e.g. application of a write strategy as will be explained in more detail in connection with FIG. 4 below.

FIG. 4 schematically shows an embodiment of the optical pick-up unit (OPU) 20, where the second clock generator 24 transmits the retrieved clock signal CLKr to a phase lock loop circuit (PLL) 25 adapted to extract substantially the clock signal CLK again. The second clock generator 24 can be a zero-level comparator, a middle-level comparator or similar circuits.

The clock signal CLK from the circuit 25 is applied by the demodulator 23 for extracting the encoded signal NRZ. Preferably, the clock signal CLK is applied in anti-phase for the demodulation. If needed, the data signal NRZ can be retimed back into the normal clock domain.

The data demodulation can be performed in many different ways readily available to the skilled person once the general principle of the present invention is acknowledged. In one embodiment, the duty cycle of the retrieved clock signal CLK from the PLL circuit 25 is substantially 50%. In the phase-modulation scheme illustrated in FIG. 3, where the failing edge is phase-modulated and the rising edge is used for clock determination, the two phases ph(1) and ph(−) may then be chosen so that the clock phase of the PLL is arranged to fall half-way between the NRZ=1 and NRZ=0 phase. This will result in a duty cycle of the combined signal NRZ_CLK alternating between 25% and 75% in response to the data signal NRZ.

Additionally, the NRZ data signal is transmitted to the resampling means 27, where the NRZ data signal is further optimized by resampling using the main clock signal CLK received by the resampling means 27 from the phase lock loop (PLL) circuit 25. Resampling can be performed by e.g. flip-flop devices as shown e.g. in WO 2005/001829 (to the same applicant), which is hereby included by reference in its entirety. Resampling can include signal and/or amplitude off-setting, followed by clipping and bottoming of the signal. Subsequently, the resampled NRZ data signal is sent to the write strategy generator (WSG) 26 for processing of a corresponding write pulse train to the irradiation source 4.

The resampling performed by the resampling means 27 can be optimised in response to the phase-modulation of the two phases; ph(−1) and ph(+1). In one optimising embodiment, the phase-modulation can be performed by varying at least one of the two phases, ph(−1) and ph(+1), until a phase jump is seen in resampling data signal NRZ, and then adding 180 degrees to the phase in order to get the highest possible phase distance to the undesirable phase jump. Furthermore, the optical drive can be adapted to run such a calibration procedure so as to optimise the phase-modulation with respect to the resulting resampled data signal NRZ. This calibration can be performed prior to a writing process or during an intermission of a writing process. For BD or BD-like writing, the said calibration procedure can be performed during run-in or run-out of writing.

In one embodiment of the invention which is not illustrated in FIG. 4, the data demodulator 23 comprises a plurality of parallel demodulating sub-units, and the resampling means 27 comprises a corresponding plurality of resampling sub-units where both types of sub-units are collectively arranged to demodulate and resample a plurality m of encoded data channels. Thus, the data demodulator 23 can additionally function as a demultiplexer. Advantageously, each of the encoded data channels of the plurality m of encoded data channels is assigned to a separate phase of the main clock frequency CLK. This allows parallel processing in the OPU 20 at a lower frequency than the frequency of the main clock signal CLK. Accordingly, the write strategy generator 26 is adapted for processing an incoming NRZ data stream organized in a parallel of m data channels.

FIG. 5 is a flow-chart of a method according to the invention, the method comprising the steps of:

S1 processing by processing means 50 an encoded data signal (NRZ),

S2 generating by a first clock generator 52 a two-level clock signal CLK, and

S3 modulating by a duty cycle modulator MOD said clock signal CLK in response to the encoded data signal NRZ so as to vary the duty cycle of said clock signal CLK, and outputting a single, combined data and clock signal NRZ_CLK,

S4 extracting by a second clock generator 24 a retrieved clock signal CLKr from the combined signal NRZ_CLK, said second clock generator being positioned in an optical pick-up unit (OPU) 20 comprising an irradiation source (4) and a corresponding drive device (LDD) 22, said optical pick-up unit being operably connected to the processing means 50 for receiving said combined signal (NRZ_CLK), and

S5 extracting by a data demodulator (DEMOD) 23 said encoded data signal NRZ using said retrieved clock signal CLKr.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical recording apparatus for recording information on an associated optical carrier (1), said apparatus comprising:
processing means (50) arranged for processing an encoded data signal (NRZ), said processing means comprising:
a first clock generator (52) capable of generating a two-level clock signal (CLK), and
a duty cycle modulator (MOD) arranged for modulating said clock signal (CLK) in response to the encoded data signal (NRZ) so as to vary the duty cycle of said clock signal (CLK), and outputting a single, combined data and clock signal (NRZ_CLK), and
an optical pick-up unit (OPU; 20) comprising an irradiation source (4) and a corresponding drive device (LDD; 22), said optical pick-up unit being operably connected to the processing means (50) for receiving said combined signal (NRZ_CLK), said drive device comprising:
a second clock generator (24) capable of extracting a retrieved clock signal (CLKr) from the combined signal (NRZ_CLK), and
a data demodulator (DEMOD; 23) capable of extracting said encoded data signal (NRZ) using said retrieved clock signal (CLKr).

2. An apparatus according to claim 1, wherein the drive device (LDD; 22) is operably connected to the processing means (50) through a single electrical conductor means arranged for transmitting the single, combined data and clock signal (NRZ_CLK).

3. An apparatus according to claim 1, wherein the drive device (LDD) further comprises resampling means (27) arranged for resampling, and outputting the encoded data signal (NRZ).

4. An apparatus according to claim 1, wherein the second clock generator (25) is adapted to extract the two-level clock signal (CLK).

5. An apparatus according to claim 3, wherein the data demodulator (DEMOD; 23) comprises a plurality of parallel demodulating sub-units, and the resampling means (27) comprises a corresponding plurality of resampling sub-units, said sub-units being collectively arranged to demodulate and resample a plurality (m) of encoded data channels.

6. An apparatus according to claim 4, wherein each of the encoded data channels (65) of the plurality (m) of encoded data channels (65) is assigned to a separate phase of the two-level clock frequency signal (CLK).

7. An apparatus according to claim 1, wherein the two-level clock signal (CLK) is duty-cycle modulated by a phase-modulation relative to a rising edge or a falling edge of the two-level clock signal (CLK).

8. An apparatus according to claim 3, wherein the phase-modulation is chosen so as to optimise the resampling performed by the resampling means (27).

9. An apparatus according to claim 8 further being adapted to perform a calibration procedure in order to optimise the phase-modulation.

10. An apparatus according to claim 1, wherein a plurality of phases are applied in modulating said clock signal (CLK).

11. An apparatus according to claim 1, wherein the optical recording apparatus is arranged for being operated in constant angular velocity (CAV) mode.

12. Processing means (50) adapted for controlling an associated optical recording apparatus for recording information on an optical carrier (1), the processing means being arranged for processing an encoded data signal (NRZ), said processing means (50) comprising:
a first clock generator (52) capable of generating a two-level clock signal (CLK), and
a duty cycle modulator (MOD) arranged for modulating said clock signal (CLK) in response to the encoded data signal (NRZ) so as to vary the duty cycle of said clock signal (CLK) and outputting a single, combined data and clock signal (NRZ_CLK) being intended for transmission to an optical pick-up unit (OPU; 20) of the associated optical recording apparatus.

13. A method for operating an optical recording apparatus for recording information on an optical carrier (1), said method comprising the steps of:
processing by processing means (50) an encoded data signal (NRZ),
generating by a first clock generator (52) a two-level clock signal (CLK), and
modulating by a duty cycle modulator (MOD) said clock signal (CLK) in response to the encoded data signal (NRZ) so as to vary the duty cycle of said clock signal (CLK) and outputting a single, combined data and clock signal (NRZ_CLK),
extracting by a second clock generator (24) a retrieved clock signal (CLKr) from the combined signal (NRZ_CLK), said second clock generator being positioned in an optical pick-up unit (OPU; 20) comprising an irradiation source (4) and a corresponding drive device (LDD; 22), said optical pick-up unit being operably connected to the processing means (50) for receiving said combined signal (NRZ_CLK), and
extracting by a data demodulator (DEMOD; 23) said encoded data signal (NRZ) using said retrieved clock signal (CLKr).

14. A computer program product being adapted to enable a computer system comprising at least one computer having data storage means associated therewith to control an optical recording apparatus according to claim 13.
